(19) United States
(12) Patent Application Publication
(10) Pub. No.: US 2016/0267245 A1
(43) Pub. Date: Sep. 15, 2016

(54) METHOD AND DEVICE FOR PREDICTING MUTATED GENOME SEQUENCES, AND STORAGE MEDIUM OF STORING MUTATED GENOME SEQUENCE PREDICTION PROGRAM

(71) Applicant: KOREA INSTITUTE OF SCIENCE AND TECHNOLOGY INFORMATION, Yuseong-gu Daejeon (KR)

(72) Inventor: In Sung AHN, Daejeon (KR)

(21) Appl. No.: 14/404,108

(22) PCT Filed: Aug. 21, 2014
(86) PCT No.: PCT/KR2014/007784

§ 371 Date: Nov. 26, 2014

(30) Foreign Application Priority Data
Dec. 27, 2013 (KR) 10-2013-0165876

(51) Int. Cl. G06F 19/00; G06N 7/00

(52) U.S. Cl. CPC G06F 19/3437; G06N 7/005

(57) ABSTRACT

The present invention relates to a storage medium for storing a mutated genome sequence prediction program to receive input of a first genome sequence group and a second sequence group including each of a plurality of genome sequences, to calculate genome mutation between the first genome sequence group and the second genome sequence group using a distributed processing technique, to generate multiple mutation parameters represented by a 61 by 61 matrix using the calculation result, to generate mutated genome sequences of seed genome sequences using the multiple mutation parameters, and to display the generate mutated genome sequences.

### TECHNICAL FIELD

The present invention relates to a method and a device for predicting mutated genome sequences, and more particularly, to a method and a device for predicting mutated genome sequences using generated multiple mutation parameters after generating the multiple mutation parameters by dividing each of different genome sequence groups into a codon unit and then by calculating genome mutation between genome sequence groups, and a program performing the same.

### BACKGROUND ART

Codons as minimum genetic code units mean a combination of three bases of mRNA determining amino acid sequences of a protein. Codons are classified into a total of sixty-four classes including three codons, which may be used to inhibit protein synthesis, and sixty-one codons, which may be used to determine a kind of amino acids. In this regard, the total number of amino acids determined by the sixty-one codons is twenty. However, one codon does not determine one amino acid and a plurality of codons may repetitively determine the same amino acid. Codons determining an identical amino acid are called “synonymous codons”.

When appearance frequencies of codons are interpreted with gene sequences of each of biological species, it can be confirmed that synonymous codons may not be uniformly used and specific codons of a plurality of synonymous codons are ununiformly distributed and used.

Such a codon appearance tendency or use tendency is called “codon-usage” and differences in the frequency or the use frequency of synonymous codons are called “codon-usage bias”.

When use frequencies of specific synonymous codons between two different biological species, namely, codon-usage biases, are similar, the biological species may be evolutionally related. In this way, evolutionary pattern of each biological species, an evolutionary pattern of each virus and the like may be analyzed in detail at the codon unit through codon-usage bias analysis.

### DISCLOSURE

### Technical Problem

For several years, a variety of analytical parameters to test codon-usage bias, and a method, a device, and the like reflecting association of synonymous codons have been developed. However, when association of adjacent synonymous codons in timeserial genome sequences is calculated, biological characteristics such as a mutation degree differently exhibited per genome part may not be properly reflected. Therefore, an object of the present invention devised to solve the problem lies in a method and a device to reflect genome analysis according to specificity of each biological species at the codon level using association between synonymous codons and biological characteristics differently exhibited per genome part, and a storage medium for storing a mutated genome sequence prediction program.

Particularly, an object of the present invention devised to solve the problem lies in a method and a device to predict mutated genome sequences by sequentially comparing mutation degrees of different genome sequences belonging to different genome sequence groups at the codon unit corresponding to an identical position, not in a synonymous codon unit, and a storage medium to store a program performing the same.

### Technical Solution

The object of the present invention can be achieved by providing a method of predicting mutated genome sequences may include receiving input of a first genome sequence group and a second genome sequence group, calculating a mutation state between the first genome sequence group and the second genome sequence group using a distributed processing technique, each of the first genome sequence group and the second genome sequence group including a plurality of genome sequences, generating multiple mutation parameters using the calculation result, each of the multiple mutation parameters being represented by a 61 by 61 matrix, generating mutated genome sequences of seed genome sequences using the multiple mutation parameters, and displaying the generated mutated genome sequences.

### Advantageous Effects

Effects of the present invention are as follows:

First, genome analysis in accordance with specificity of each biological species may be conducted by calculating association of adjacent synonymous codons designating each of amino acids. That is, high-level distinction information to distinguish each biological species may be provided at the codon level.

Second, difference in result values due to different lengths of subject genome sequences is reduced by changing into a value relative to the sum of each column after representing association of codons by matrices and, as such, genome comparison between different biological species may be performed in greater detail.

Third, information regarding a different mutation degree per each genome region as biological characteristics, by comparison between groups of genome sequences may be provided.

Fourth, by reflecting information regarding a different mutation degree per each genome region as biological characteristics, in a simulation, future mutation may be accurately predicted.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a base constituting mRNA and a combination of codons;

FIG. 2 illustrates a block of a device for calculating a codon association pattern in genome sequences according to one embodiment of the present invention;

FIG. 3 is a conceptual diagram illustrating a process of exploring SCA in a synonymous codon exploration module 2100 according to one embodiment of the present invention;

FIG. 4 illustrates a portion of an SCAM according to one embodiment of the present invention;

FIG. 5 illustrates a device for predicting mutated genome sequences according to one embodiment of the present invention.

FIG. 6 illustrates a process of calculating genome mutation based on a distributed processing technique according to one embodiment of the present invention;

FIG. 7 illustrates a process of predicting mutated genome sequences according to one embodiment of the present invention; and

FIG. 8 is a flowchart illustrating a method of predicting mutated genome sequences according to one embodiment of the present invention.

### BEST MODE

Other objectives, characteristics and advantages of the present invention will become apparent through detailed description of examples with reference to the accompanying drawings.

Hereinafter, constitutions and effects of examples according to the present invention will be described with reference to the accompanying drawings, the constitutions and effects of the present invention illustrated in the drawings and explained thereby are explained as at least one embodiment, and technical ideas, fundamental constitutions and effects of the present invention are not limited thereto.

An origin of an influenza A virus occurred in 2009 is known as Eurasian avian-swine influenza (H1N1) and a triple-reassortant virus prevalent among swine in North America.

Genetic segments of the new influenza A virus are known as being developed from a variety subtypes such as PB2 and a PA gene of an avian virus of North America, a PB1 gene of an H3N2 virus of humans, an NS gene of a traditional swine virus, and NA and M genes of Eurasian avian-swine influenza virus.

Especially, an influenza A virus (H1N1) originated from swine influenza affects humans and 200 soldiers or more were infected in Fort Dix, N.J., 1979. At that time, infection was spread from person to person. However, at that time, a vaccine campaign was conducted all around the United States and thereby the influenza A virus originated from swine did not proceed to a serious epidemic state.

The new influenza viruses may be named H1N1. In H1N1, H is an abbreviation of hemagglutinin and N is an abbreviation of neuraminidase.

A virus consists of nucleic acid as a genetic material and a protein shell surrounding the nucleic acid, and includes a genetic material. However, viruses do not have a system to express the genetic material and thereby, when viruses exist alone, the viruses cannot do life activity at all. However, when viruses meet proper host cells, viruses may invade specific host cell kinds satisfying characteristics thereof and then may perform their life activity. In this regard, viruses may invade specific host cell types satisfying their characteristics and, when viruses invade host cells, two forks types, namely, H and N, consisting of proteins existing on surfaces of viruses may be used.

The proteins existing on surfaces of viruses as described above are important components of organisms as connectors of amino acids. Proteins may differ in accordance with the number, kind and binding sequence of an amino acid constituting each protein, and protein types are varied. The number of amino acid types is known as being totally twenty. Amino acid names and abbreviations are summarized in Table 1 below.

TABLE 1

| Amino | Three | One | | Three | |
|---|---|---|---|---|---|
| acids | letter | letter | Amino acids | letter | One letter |
| Alanine | Ala | A | Glycine | Gly | G |
| Lysine | Lys | K | Leucine | Leu | L |
| Asparagine | Asn | N | Proline | Pro | P |
| Aspartic | Asp | D | Threonine | Thr | T |
| acid | | | | | |
| Cysteine | Cys | C | Phenylalaine | Phe | F |
| Histidine | His | H | Arginine | Arg | R |
| Isoleucine | Ile | I | Tyrosine | Tyr | Y |
| Methionine | Met | M | Tryptophan | Trp | W |
| Serine | Ser | S | Glutamic | Glu | E |
| | | | acid | | |
| Valine | Val | V | Glutamine | Gln | Q |

A minimum unit of genetic codes indicating the above amino acids is called a codon.

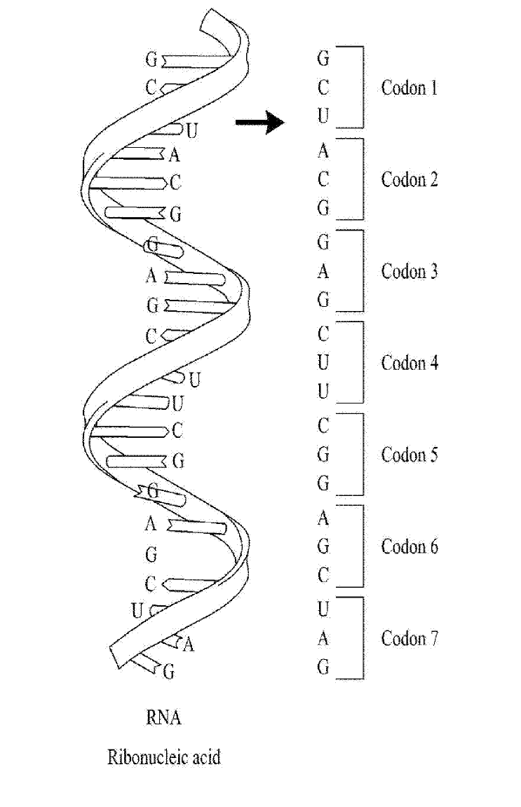

FIG. 1 illustrates bases constituting mRNA and a combination of codons.

Codons are combinations of mRNA bases indicating amino acid types of proteins. As illustrated in FIG. 1, bases of mRNA consist of a total of four bases, namely, uracil, adenine, cytosine and guanine, which may be represented by English capital letters, namely, U, A, C and G, respectively.

Codons may consist of combinations of three bases among the four bases. For example, as illustrated in FIG. 1, codon 1 may consist of GCU, codon 2 may consist of ACG, and codon 3 may consist of GAC. Accordingly, three bases to form a codon may be selected from four bases, namely, U, A, C and G, and the number of a combination thereof may be a total of sixty-four as a result of 4×4×4.

However, three codons of sixty-four codons may be used to stop protein synthesis and the other sixty-one codons may be used to determine or indicate twenty amino acids. However, since the number of codon types is larger than the number of amino acid types, corresponding relation of 1:1 to indicate one amino acid with one codon is not formed. Accordingly, a plurality of codons may repetitively indicate the same amino acid. Like this, a plurality of codons indicating an identical amino acid is called a synonymous codon.

In Table 2 below, codon types and amino acids indicating synonymous codons are summarized.

TABLE 2

| | | Second position of codon | | | | | | | | | |
|---|---|---|---|---|---|---|---|---|---|---|---|
| | | U | | C | | A | | G | | | |
| | | | Amino | | Amino | | Amino | | Amino | | |
| | | Code | acid | Code | acid | Code | acid | Code | acid | | |
| First | U | UUU | Phe | UCU | Ser | UAU | Tyr | UGU | Cys | U | Third |
| position of | | | | | | | | | | | position of |
| codon | | | | | | | | | | | codon |
| | | UUC | | UCC | | UAC | | UGC | | C | |
| | | UUA | Leu | UCA | | UAA | STOP | UGA | STOP | A | |
| | | UUG | | UCG | | UAG | STOP | UGG | Trp | G | |
| | C | CUU | Leu | CCU | Pro | CAU | His | CGU | Arg | U | |
| | | CUC | | CCC | | CAC | | CGC | | C | |
| | | CUA | | CCA | | CAA | Gln | CGA | | A | |
| | | CUG | | CCG | | CAG | | CGG | | G | |
| | A | AUU | Ile | ACU | Thr | AAU | Asn | AGU | Ser | U | |
| | | AUC | | ACC | | AAC | | AGC | | C | |
| | | AUA | | ACA | | AAA | Lys | AGA | Arg | A | |
| | | AUG | Met | ACG | | AAG | | AGG | | G | |
| | G | GUU | Val | GCU | Ala | GAU | Asp | GGU | Gly | U | |
| | | GUC | | GCC | | GAC | | GGC | | C | |
| | | GUA | | GCA | | GAA | Glu | GGA | | A | |
| | | GUG | | GCG | | GAG | | GGG | | G | |

As shown in Table 2, a codon UUU and a codon UUC may indicate the same amino acid, Phe. Accordingly the codon UUC and the codon UUU may be synonymous codons.

As one embodiment of the present invention, the above synonymous codons, namely, the codon UUU and the codon UUC, may be represented by Phe 1 and Phe 2, respectively, using an abbreviation of an amino acid indicating each synonymous codon and a number.

In addition, amino acids may be classified in accordance with degeneracy tendency. Degeneracy tendency may be classified into the number of synonymous codons to indicate a relevant amino acid. Generally, an n-fold degenerate amino acid may have N synonymous codons to indicate a relevant amino acid. As one embodiment of the present invention, the twenty amino acids are classified into a 2-fold degenerate amino acid group, a 4-fold degenerate amino acid group and 6-fold degenerate amino acid group.

The 2 fold-degenerate amino acid group includes Ile, Gln, His, Phe, Met. Cys, Tyr, Trp, Asn, Asp, Glu and Lys, and the 4-fold degenerate amino acid group includes Pro, Ala, Val, Gly and Thr. In addition, the 6-fold degenerate amino acid group includes Leu, Ser and Arg.

When appearance frequencies of all codons after collecting gene sequences of each biological species are interpreted, it can be confirmed that synonymous codons to indicate an identical amino acid are not uniformly used and specific synonymous codons are biasedly used.

Like this, appearance tendency or use tendency of codons is called codon-usage and differences in appearance frequency numbers or use frequency numbers of synonymous codons are called codon-usage bias.

Accordingly, when a use frequency, namely, codon-usage bias, of a specific synonymous codon is similar between different two biological species, both biological species may be evolutionally related. In addition, when codon-usage of a protein existing on a surface of a virus is analyzed on a year-on-year basis, an evolutionary pattern of a virus surface protein may be analyzed, and the direction of vital evolution may be predicted. In addition, origins of viruses, association between viruses and the like may be predicted at the codon unit.

Like this, using codon-usage bias, evolutionary patterns between each biological species, evolutionary patterns and origins of viruses, and the like may be analyzed in detail at the codon unit.

Through several years, to test codon-usage bias, a variety of analytical parameters such as effective numbers of codons (ENC), relative synonymous codon usage (RSCU), and the like have been developed.

ENC may have a value from at least 20 up to 61 as a codon-usage parameter. When dramatic codon-usage is exhibited as a case that one codon indicates 20 amino acid types, an ENC value may be 20. In addition, when all codons are used to identically indicate 20 amino acid types, an ENC value may be 61. Generally, when an ENC value exceeds 40, it may be considered that codon-usage bias is low. One ENC value may be obtained by calculating each subject genome sequence and, regardless of characteristics of an amino acid group, an average pattern of codon-usage bias may be represented by one representative value.

RSCU is a codon-usage parameter and an RSCU value may be obtained by dividing appearance frequency of a codon in a subject genome sequence by an expectation value of an appearance frequency number. An RSCU value may be calculated through Mathematical Equation 1 below.

RSCUij=Xij/ΣXij/ni [Mathematical Equation 1]

Xij represents use frequency of a codon i indicating an ith amino acid and ni represents the number of all synonymous codons which may indicate a subject amino acid group. An RSCU value has an advantage in that characteristics of an amino acid group may be reflected, when compared to an ENC value. However, the RSCU value has a drawback in that association between synonymous codons is excluded and only codon-usage bias of genome sequences only is represented.

Accordingly, the present invention provides a device and a method to calculate possible association between synonymous codons. Especially, by representing association between synonymous codons in a matrix having a unique color, an identification device and method of a codon level to visibly represent association are provided.

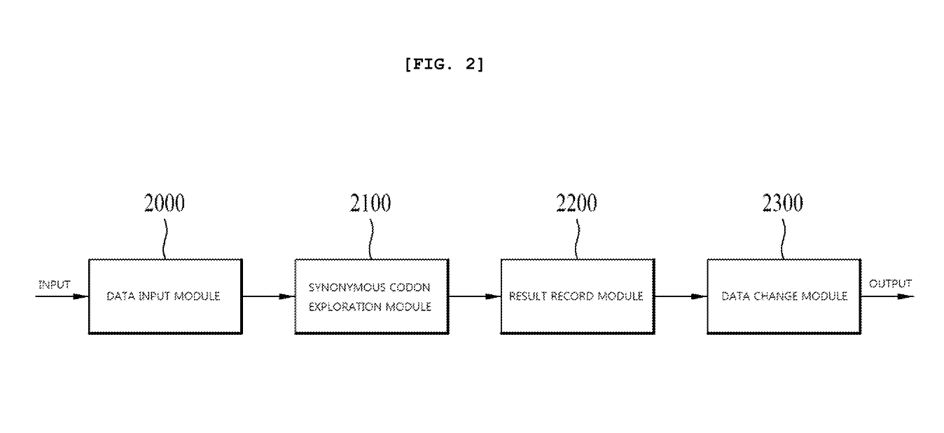

FIG. 2 is a block diagram of a device calculating codon association patterns in genome sequences according to one embodiment of the present invention.

Input date of the present invention may be sequences of each gene and, as one embodiment, influenza virus date available from National Center for Biotechnology Information may be used. In addition, as one embodiment, input data of the present invention may be necessary nucleotide sequences parsed in accordance with categories after removing unclear one nucleotide sequence or a plurality of nucleotide sequences from basic source data. In addition, categories according to the present invention may be a receipt number, a relevant year, a gene name, a host, a sub-type, and the like. As one embodiment, parsing necessary nucleotide sequences of the present invention may be performed through a program written in JAVA.

As one embodiment of the present invention, input data may be 859 sequences of human H1N1 virus sub-type HA, 841 sequences of human H1N1 virus sub-type NA, 159 sequences of avian H1N1 virus sub-type HA, 147 sequences of avian H1N1 virus sub-type NA, 1178 sequences of human H3N2 virus sub-type HA, and 1253 sequences of human H3N2 virus sub-type NA.

As illustrated in FIG. 2, a codon association pattern calculation device according to one embodiment of the present invention may include a data input module 2000, a synonymous codon exploration module 2100, a result record module 1200 and a data change module 2300. Hereinafter, each module will be described.

An input module 2000 of subject data divides one unit of nucleotide sequence into a codon unit, namely, a unit of three base sequences and then the divided nucleotide sequences are sequentially output through the synonymous codon exploration module 2100 from a first sequence.

To analyze codon-usage relation, the synonymous codon exploration module 2100 may search for a synonymous codon of a present input codon by scanning sequentially from codons input from the subject data input module 2000 to subsequent codons and then may calculate a kind thereof. In this regard, as one embodiment, the synonymous codon exploration module 2100 may search for a synonymous codon nearest a present input codon. In the present invention, the codon-usage relation may be called a synonymous codon relation (SCA). Particular contents will be described below.

A result record module 2200 may record the kind of synonymous codons forming a pair with a subject codon and a value according to the exploration result, using an exploration result output from the synonymous codon exploration module 2100. The result record module 2200 may be included in the synonymous codon exploration module 2100 and may be modified in accordance with a designer.

As one embodiment of the present invention, the exploration result is recorded in a 61 by 61 matrix. Such a 61 by 61 matrix may be called a synonymous codon association matrix (SCAM).

Each column of the SCAM means subject codons and each column may be represented in an amino acid unit indicated by subject codons. In addition, a row of the SCAM means synonymous codons and the row may be represented in a unit of an amino acid indicated by synonymous codons. The number of codons indicating amino acids is a total of 61 and thereby, in each of the column and the row, sixty one codons are represented. Accordingly, the SCAM has a structure of a 61 by 61 matrix.

Subsequently, the data change module 2300 may change the SCAM data generated by the result record module 2200 into an association matrix representing a relative value for the sum of each column. As one embodiment, a matrix changed like this may be called a synonymous codon transition matrix (SCTM). Particular contents will be described below.

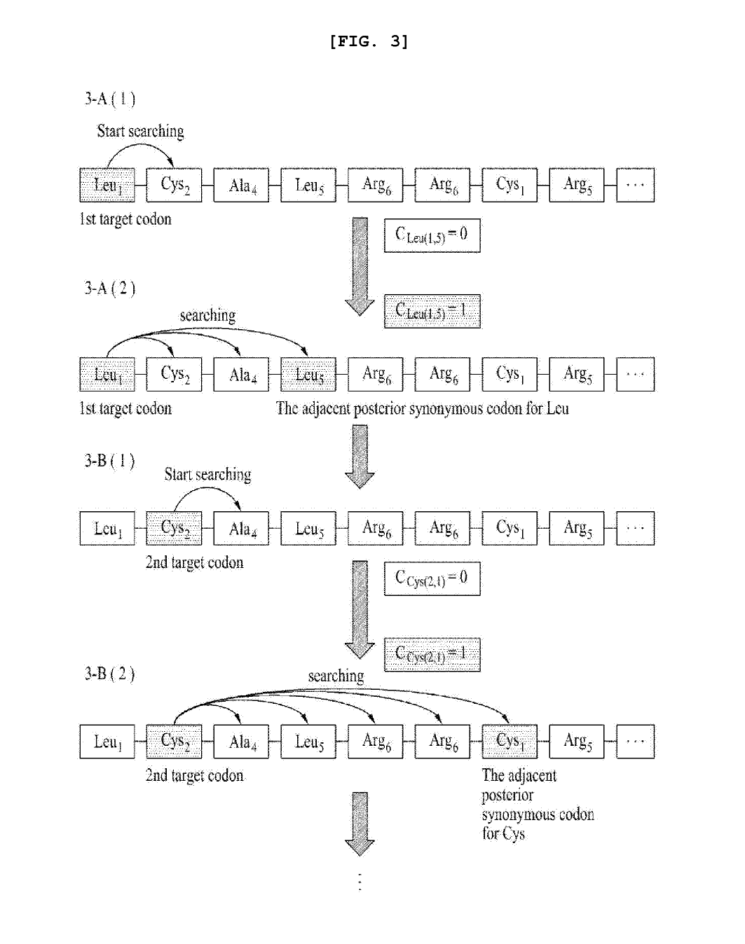

FIG. 3 is a conceptual diagram illustrating a process of exploring SCA in the synonymous codon exploration module 2100 according to one embodiment of the present invention.

As described above, the subject data input module 2000 may sequentially output codons through the synonymous codon exploration module 2100 after dividing genome sequences or nucleotide sequences into a codon unit. the synonymous codon exploration module 2100 may explore SCA of sequentially input codons. In the present invention, a designated codon to explore SCA may be called a subject codon or a target codon. Subsequently, the synonymous codon exploration module 2100 may explore a synonymous codon at the most adjacent position to the subject codon of sequentially input codons after input of the subject codon.

In FIG. 3-A, (1) and (2) are conceptual diagrams illustrating an exploration process when the subject codon is Leu 1. In FIG. 3-B, (1) and (2) are conceptual diagram illustrating an exploration process when the subject codon is Cys 2. Hereinafter, each conceptual diagram will be described.

As illustrated in FIG. 3-A (1), the synonymous codon exploration module 2100 may sequentially receive input of codons in the order of Leu1, Cys2, Ala4 and so on. As described above, a Leu1 codon means a codon designating an amino acid Leu, synonymous codons of Leu1 may be called Leu2, Leu3 and the like.

The synonymous codon exploration module 2100 designates a firstly input codon, namely, Leu1, as a first subject codon and may explore whether synonymous codons of codons input after Leu1 are present. Since a codon input after Leu1 is Cys2, which designates the amino acid Cys, it is not a synonymous codon of Leu1. Subsequently, the synonymous codon exploration module 2100 may continuously explore codons input in sequence.

As illustrated in FIG. 3-A (2), the synonymous codon exploration module 2100 may sequentially explore codons input after Cys2 and thereby may detect a synonymous codon Leu5 in a third exploration process. Here, the synonymous codon Leu5 is a synonymous codon nearest the subject codon and thereby the number of a synonymous codon Leu5 detected as an exploration result is 1. Therefore, a relevant cell value of an SCAM of the result record module 2200 may be 1. Subsequently, the synonymous codon exploration module 2100 may continuously explore sequentially input codons. If a synonymous codon Leu 5 is repeatedly detected through an exploration process, a relevant cell value of an SCAM may be changed from 1 to 2. In addition, when a new synonymous codon Leu4 is detected in an exploration process, a relevant cell value of an SCAM may be 1.

When exploration for all synonymous codons of a subject codon Leu1 is finished, the synonymous codon module 2100 may designate a secondly input codon as a new subject codon and may start exploration to search for a new synonymous codon.

As illustrated in FIG. 3-B (1), the synonymous codon exploration module 2100 may designate a codon Cys 2 input after Leu1 as a second subject codon and may explore synonymous codons.

As illustrated in FIG. 3-B (2), the synonymous codon exploration module 2100 may detect a synonymous codon, namely, Cys1, in a fifth exploration. As described above, the number of the synonymous codon Cys2 is 1 and thereby a relevant cell value of an SCAM may be 1. Subsequently, when the synonymous codon exploration module 2100 repeatedly detects the synonymous codon Cys 1 through a continuous exploration process, a relevant cell value of an SCAM may be changed from 1 to 2. If Cys2 identical to the subject codon is detected, a relevant cell value of an SCAM may be 1.

When exploration for all synonymous codons of the subject codon Cys2 is finished, the synonymous codon module 2100 may designate thirdly input Ala4 as a third subject codon and may perform the exploration process described above.

In this way, the synonymous codon exploration module 2100 may perform a process to detect synonymous codons by designating one codon of sequentially input codons designating 20 amino acid types as a subject codon and exploring all input codons.

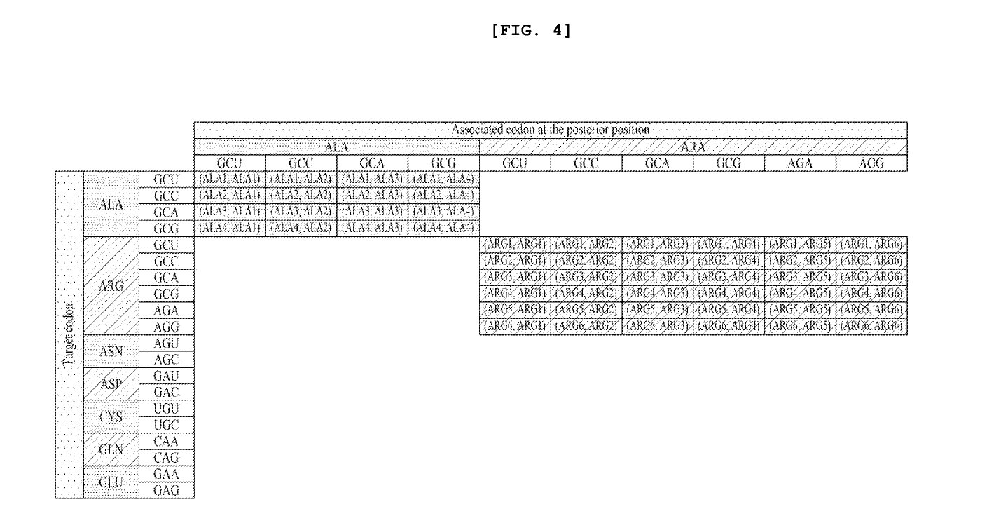

FIG. 4 is a view illustrating a portion of the SCAM according to one embodiment of the present invention.

As described above, the result record module 2200 may record types of synonymous codons forming a pair with a subject codon and a value according to the exploration result in an SCAM of a 61 by 61 matrix, using an exploration result output from the synonymous codon exploration module 2100.

In each cell of the SCAM, the subject codon and types of synonymous codons detected through exploration may be displayed and each cell may have a value in accordance with the exploration result of the synonymous codon exploration module 2100. FIG. 4 is a magnified view of a portion of the SCAM according to one embodiment of the present invention.

As illustrated in FIG. 4, synonymous codons indicating an amino acid Ala illustrated in a first column consists of a total of four codons, namely, GCU, GCC, GCA and GCG. As described above, GCU may be called Ala1, GCC may be called Ala2, GCA may be called Ala3, and GCG may be called Ala4.

A cell in a first column and a first row of the SCAM means that a subject codon is Ala1 and a synonymous codon detected through exploration is also Ala1. In this case, the cell may be represented by C(Ala1, Ala1) or CAla(1,1), and the value of a relevant cell may be any one value of 1, 2, and the like in accordance with the exploration result. Similarly, in a cell of a 1a column and 2a row of the SCAM, a subject codon is Ala1 and a synonymous codon detected through exploration is Ala 2, and thereby, the cell may be represented by (Ala1, Ala2) and a cell value may be any one value of 1, 2, and the like in accordance with an exploration result.

The result record module 2200 may perform recording for the other subject codons in an identical manner as described above.

As described above, the data change module 2300 may change a cell value of an SCAM generated from the result record module 1200 into an SCTM representing a relative value based on the sum of each column. The SCTM may be constituted with a 61 by 61 matrix identical to the SCAM, each column represents a subject codon, and each column may group and display an amino acid indicating the subject codon. In addition, each row represents synonymous codons detected through exploration, each row may displayed by grouping amino acids indicating synonymous codons. That is, each column and each row of the SCTM are identical to the column and the row of the SCAM illustrated in FIG. 3.

As one embodiment of the present invention, to minimize calculation deviation between subject codons, a cell value of an SCAM is calculated and then is changed into an SCTM using a transition probability concept of Markov theory.

A relative value PAA(i,j) displayed in each cell of the SCTM may be calculated through Mathematical Equation 2 below.

$$PAA ( i , j ) = \frac{CAA ( i , j )}{SAA ( i , )} \qquad ( Mathematical Equation 2 )$$

PAA(i,j) means a relative value of an ith column subject codon and a jth row synonymous codon of the SCAM, AA means a name of each amino acid indicated by each synonymous codon. For example, a first column and a first row of an SCAM illustrated in FIG. 2 is a codon of amino acid alanine and thereby a relative value may be represented by PAla(1,1).

As described above, CAA(i,j) means each cell value of the SCAM and the value may be 1, 2, 3, or the like. In addition, SAA(i,) means the sum of each column of the SCAM. That is, PAA(i,j) may have characteristics in accordance with Mathematical Equations 3 and 4 below.

0≦PAA(i,j)≦1 [Mathematical Equation 3]

In addition, all i must satisfy Mathematical Equation 4 below.

$${\sum }_{j = 1}^{n} PAA ( i , j ) = 1 \qquad ( Mathematical Equation 4 )$$

In Mathematical Equation 4, n means the number of synonymous codons of each amino acid.

As one embodiment of the present invention, to more easily explain association between synonymous codons indicating each amino acid, TTR as a parameter may be used. TTR is an abbreviation of a TPAhomo/TPAhetero ratio and TPA means transition probability of synonymous codon association. The TPAhomo means the sum of TPA when a subject codon and an explored synonymous codon are identical, namely, a subject codon of FIG. 3 is Leu1 and an explored synonymous codon also is Leu1. On the other hand, TPAhetero means the sum of TPA when a subject codon and an explored synonymous codon are not identical, namely, as described in FIG. 3, a subject codon is Leu1 and an explored synonymous codon is Leu5. As one embodiment, a TPA value according to the present invention may be calculated using a transition probability of an SCTM for each amino acid group, namely, PAA(i,j).

As one embodiment of the present invention, to determine synonymous codon association in a subject gene, all SCAs of nucleotide sequences of influenza A virus are calculated. The SCTM according to one embodiment of the present invention may be an SCTM of a virus H1N1 sub-type HA and sub-type NA originated from human and a total number of the SCTM is 189.

As described above, when the device to calculate a codon association pattern in genome sequences described in FIG. 2 and a method corresponding thereto are used, genome analysis in accordance with specificity of each biological species is possible at the codon level, however, it is difficult to understand biological characteristics that a mutation state in each genome portion is differently observed.

Accordingly, in the present invention, to detect a mutation degree differently represented per genome, namely, biological characteristics, a device and a method to predict mutated genome sequences by comparing genome sequences belonging to different groups are described.

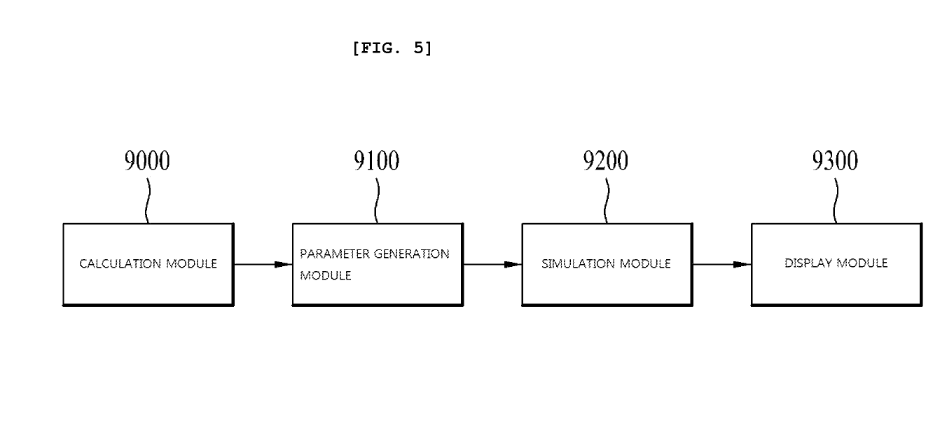

FIG. 5 illustrates a device for predicting mutated genome sequences according to one embodiment of the present invention.

The device for predicting mutated genome sequences according to one embodiment of the present invention may include a calculation module 9000, a parameter generation module 9100, a simulation module 9200 and a display module 9300. Hereinafter, the present invention will be described in conjunction with an operation of each module.

Input data of the device for predicting mutated genome sequences according to one embodiment of the present invention may be base sequences identified every year. Input data according to one embodiment of the present invention may be a variety of base sequences identified by National Center for Biotechnology Information (NCBI), European Bioinformatics Institute (EBI), DNA Data Bank of Japan (DDBJ), researchers around the world and the like. A genome sequence group according to one embodiment of the present invention is identical to a collection of genome sequences identified by year. Accordingly, according to one embodiment of the present invention, a collection of genome sequences identified in 1999 and a collection of genome sequences identified in 2000 may be treated as different groups.

The calculation module 9000 according to one embodiment of the present invention may calculate whether a genome is mutated or not using a distributed processing technique. In particular, the calculation module 9000 according to one embodiment of the present invention may compare and calculate whether base sequences in an identical region of each group are mutated or not by receiving at least two genome sequence groups as input data and then distributing each genome sequence group to a plurality of regions. Particular contents will be described below.

Subsequently, the parameter generation module 9100 according to one embodiment of the present invention may generate a transition matrix in accordance with a calculation result of the calculation module. Each transition matrix may include multiple mutation parameters in genome. The transition matrices may be a 61 by 61 matrix. Particular contents will be described below.

Subsequently, the simulation module 9200 according to one embodiment of the present invention may generate mutated genome sequences by receiving input of multiple mutation parameters from the parameter generation module 9100 and generating a mutation codon per specific positions of seed genome sequences using a multiple mutation parameter. Particular contents will be described below. Subsequently, the display module 9300 according to one embodiment of the present invention may display the generated mutated genome sequences using graphics or the like.

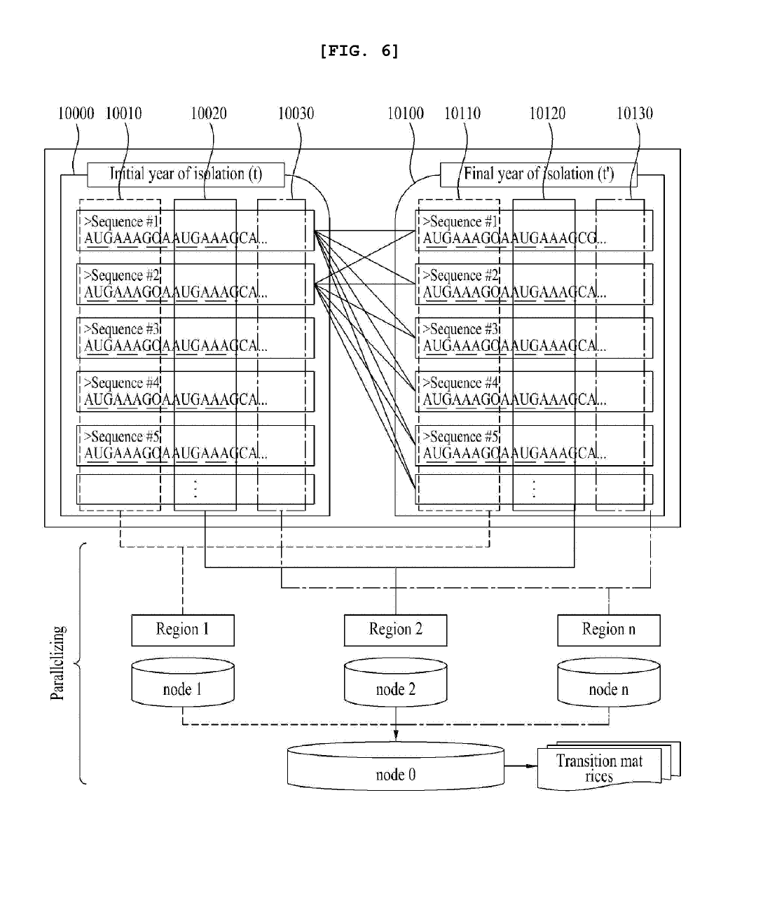

FIG. 6 illustrates a process of calculating genome mutation according to one embodiment of the present invention based on a distributed processing technique.

As described in FIG. 5, a calculation module according to one embodiment of the present invention may receive input of at least two genome sequence groups and may calculate mutation between genome sequence groups using a distributed processing technique. In particular, as illustrated in FIG. 6A, the calculation module according to one embodiment of the present invention may divide each of a first genome sequence group 10000 measured in an initial year and a second genome sequence group 10100 measured in a last year into first regions 10010 and 10110, second regions 10020 and 10120, and third regions 10030 and 10130. The number of input genome sequence groups, the number of genome sequences included in each genome sequence group, and the number of regions dividing each genome sequence group may be modified in accordance with intention of a designer.

In addition, as illustrated in FIG. 6As, names of genome sequences indicating each of genome sequences may be represented with a mark “>”. Such a marking method may be called a FASTA form.

The first regions 10010 and 10110, the second regions 10020 and 10120, and the third regions 10030 and 10130, which are described above, include base sequences to compare mutation between genome sequence groups. The calculation module according to one embodiment of the present invention may perform mutation comparison between regions having the same region name. That is, as illustrated in FIG. 6As, the calculation module according to one embodiment of the present invention may compare mutation of base sequences in a first region 10010 of the first genome sequence group 10000 and a first region 10110 of the second genome sequence group 10100, in a node 1. In an identical manner, the calculation module according to one embodiment of the present invention may perform mutation comparison of base sequences of the second regions 10020 and 10120, and the third regions 10030 and 10130, in a node 2 and a node 3. In this case, the calculation module according to one embodiment of the present invention may calculate mutation of base sequences in each region.

Subsequently, the calculation module according to one embodiment of the present invention may collect calculation results performed in a node 0 to a node 1, or a node 0 to a node 3. The collected results are input to the parameter generation module according to one embodiment of the present invention described in FIG. 5 and the parameter generation module may generate transition matrices using the calculation results of the calculation module. As described above, since mutation calculation of genome sequences is performed at the codon unit, the number of the transition matrices generated according to one embodiment of the present invention may be n/3 by dividing the length of genome sequences, namely, n, by the number of base sequences of a codon as a minimum comparison subject, namely, 3.

As a result, when the number of genome sequences of the first genome sequence group 10000 is m and the number of genome sequences of the second genome sequence group 10100 is p, the calculation module according to one embodiment of the present invention may perform mutation comparison of genome sequences a total of m×p times. Accordingly, the calculation module according to one embodiment of the present invention may calculate all possible mutation combinations between the first genome sequence group 10000 and the second genome sequence group 10100.

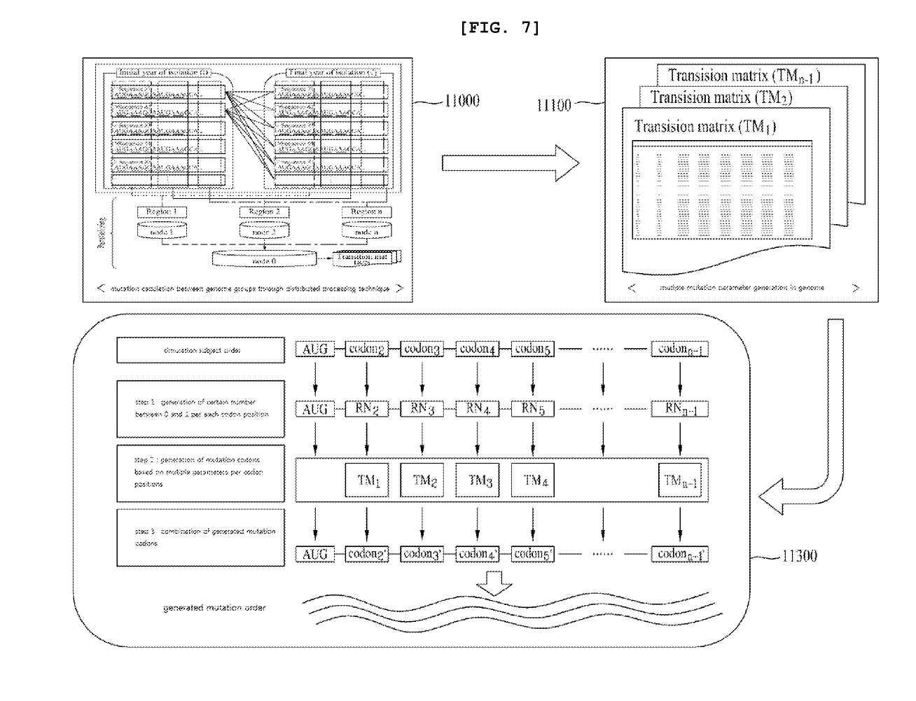

FIG. 7 is a view illustrating a process of predicting mutated genome sequences according to one embodiment of the present invention.

In FIG. 7, a block 11000 of a left upper portion is operation of the calculation module according to one embodiment of the present invention and a process of calculating genome mutation based on the distributed processing technique according to one embodiment of the present invention described in FIG. 6 is illustrated. As described above, the calculation module according to one embodiment of the present invention may output a comparison result to generate a plurality of transition matrices. In FIG. 7, a block 11100 of a right upper portion is an operation of the parameter generation module according to one embodiment of the present invention described in FIG. 5 and the parameter generation module according to one embodiment of the present invention may receive input of the comparison result output from the calculation module and then may generate a plurality of transition matrices. As described above, the number of the transition matrices according to one embodiment of the present invention may be n/3 by dividing the length of genome sequences, namely, n by the number of base sequences of a codon as a minimum comparison subject, namely, 3. That is, the transition matrices according to one embodiment of the present invention may be generated in a number of codons as a minimum comparison unit and each transition matrix may include position information of a corresponding codon.

In addition, when the total number of codons as a comparison subject of the present invention is k, AUG as an initial start codon is not mutated and thereby the total number of codons as a comparison subject is k−1 except for AUG. Accordingly, the parameter generation module according to one embodiment of the present invention may generate a total of k−1 transition matrices.

In the present invention, the k−1 transition matrices generated in the parameter generation module may be called a multiple mutation parameter or a mutation parameter and may be modified in accordance with intention of a designer.

In FIG. 7, a block 11200 in a lower portion represents an operation of the simulation module described in FIG. 5. The simulation module according to one embodiment of the present invention may modify codons in seed sequences to output mutated genome sequences by setting specific genome sequences to seed sequences and using multiple mutation parameters output from the parameter generation module. The seed genome sequences may be any one of genome sequences included in the first or the second genome sequence group and may be modified in accordance with intention of a designer.

In particular, as illustrated in the block 11200 of FIG. 7, the simulation module according to one embodiment of the present invention may select subject genome sequences (alternatively, called seed genome sequences) for simulation. The genome sequences according to one embodiment of the present invention may be called in the order of a genome. Subsequently, the simulation module according to one embodiment of the present invention may divide the seed genome sequences into a codon unit and then, certain numbers between 0 and 1 (RN2, RN3 or the like) may be generated per position of each codon.

Subsequently, the simulation module according to one embodiment of the present invention may change each of certain numbers into a codon corresponding to a position of a certain number and a stochastically identical codon or a mutated codon, using the multiple mutation parameters output from the parameter generation module.

In particular, multiple mutation parameters, namely, transition matrices, according to one embodiment of the present invention include position information of each codon. Accordingly, the simulation module according to one embodiment of the present invention may confirm that positions of specific codons corresponding to each certain number and each of transition matrices match, using codon position information included in the transition matrices. Subsequently, the simulation module according to one embodiment of the present invention may change each certain number into identical codons or mutated codons of specific codons corresponding to the certain numbers, using transition matrices.

Subsequently, the simulation module according to one embodiment of the present invention may generate mutated genome sequences by merging identical codons or mutated codons with unchanged codons of seed genome sequences when certain numbers are changed into the identical codons or the mutated codons.

Subsequently, although not illustrated in FIG. 7, the display module according to one embodiment of the present invention may visually display generated mutated genome sequences using a visual contents.

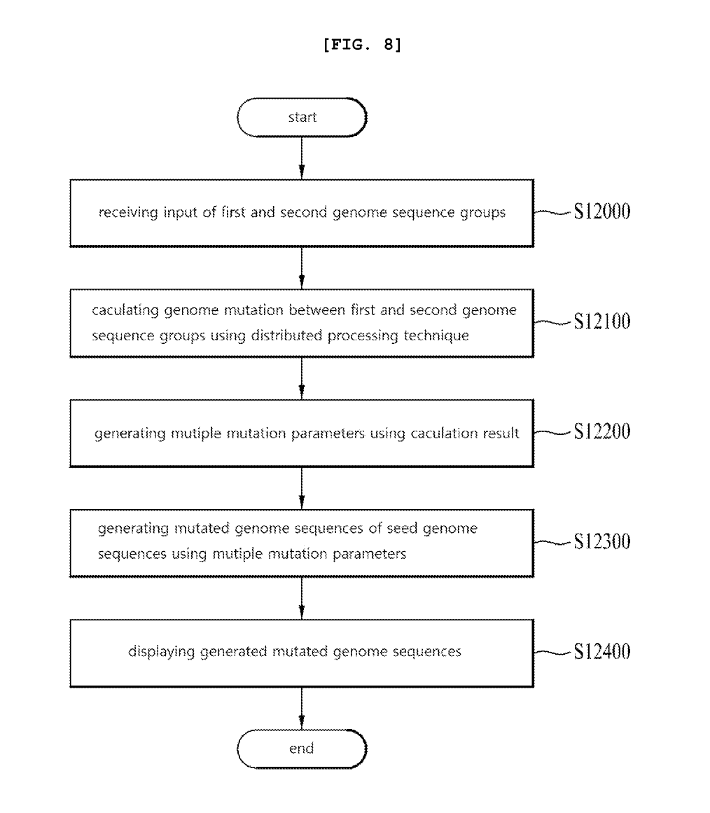

FIG. 8 is a flowchart illustrating a method of predicting mutated genome sequences according to one embodiment of the present invention.

As described above, input data of the device for predicting mutated genome sequences according to one embodiment of the present invention may be base sequences measured by year. The input data according to one embodiment of the present invention may be a variety of base sequences identified by the National Center for Biotechnology Information (NCBI), the European Bioinformatics Institute (EBI), and the DNA Data Bank of Japan (DDBJ), researchers around the world and the like. The genome sequence groups according to one embodiment of the present invention are identical to a collection of genome sequences measured by year.

The calculation module according to one embodiment of the present invention may receive input of a first genome sequence group and a second genome sequence group (S12000). In addition, the calculation module according to one embodiment of the present invention may receive input of at least two genome sequence groups. Such input data may be modified in accordance with intention of a designer.

Subsequently, the calculation module according to one embodiment of the present invention may calculate genome mutation between the first genome sequence group and the second genome sequence group using a distributed processing technique (S12100). As described above, the calculation module according to one embodiment of the present invention may divide each of the first genome sequence group and the second genome sequence group into a first region, a second region and a third region. The number of genome sequences included in each genome sequence group and the number of regions dividing each genome sequence group may be modified in accordance with intention of a designer. The first region, the second region and the third region include base sequences to compare mutation between genome sequence groups. The calculation module according to one embodiment of the present invention may perform a mutation comparison between regions having the same region name. In this case, the calculation module according to one embodiment of the present invention may calculate mutation of base sequences in each region at the codon unit as a smallest comparison unit. As a result, when the number of genome sequences in the first genome sequence group is m and the number of genome sequences in the second genome sequence group is p, the calculation module according to one embodiment of the present invention may perform mutation comparison between genome sequences a total of m×p times. Accordingly, the calculation module according to one embodiment of the present invention may calculate all possible mutation combinations between the first genome sequence group and the second genome sequence group.

Subsequently, the parameter generation module according to one embodiment of the present invention may generate mutation parameters using the calculation result (S12200). As described above, the parameter generation module according to one embodiment of the present invention receives input of a comparison result output from the calculation module and may generate a plurality of transition matrices. In the present invention, k−1 transition matrices generated from the parameter generation module are called multiple mutation parameters or mutation parameters and may be modified in accordance with intention of a designer.

As described above, since calculation of genome sequence mutation is performed at the codon unit, the transition matrices according to one embodiment of the present invention may be generated in a number of n/3 by dividing the length of genome sequences, namely, n, by the number of base sequences of a codon as a minimum comparison subject, namely, 3.

That is, the transition matrices according to one embodiment of the present invention may be generated in a number of codons as a minimum comparison unit and each transition matrices may include position information of a corresponding codon.

In addition, when the total number of codons as a comparison subject of the present invention is k, an initial start codon, namely, AUG, is not mutated and thereby the total number of codons as a comparison subject is a number of k−1 except for AUG. Accordingly, the parameter generation module according to one embodiment of the present invention may generate a total of k−1 transition matrices.

Subsequently, the simulation module according to one embodiment of the present invention may generate mutated genome sequences of seed genome sequences using multiple mutation parameters (S12300). The simulation module according to one embodiment of the present invention may select subject genome sequences (alternatively, called seed genome sequences) for simulation. The genome sequences according to one embodiment of the present invention may be called the order of a genome. Subsequently, the simulation module according to one embodiment of the present invention may divide seed genome sequences into codons and may generate a certain number between 0 and 1 per position of each codon.

Subsequently, the simulation module according to one embodiment of the present invention may change each of generated certain numbers into a codon corresponding to a position of each certain number and a stochastically identical codon or a mutated codon, using the multiple mutation parameters output from the parameter generation module.

In particular, multiple mutation parameters, namely, transition matrices, according to one embodiment of the present invention include position information of each codon. Accordingly, the simulation module according to one embodiment of the present invention may confirm that a position of a prior codon corresponding to each certain number and each of transition matrices match using codon position information included in the transition matrices. Subsequently, the simulation module according to one embodiment of the present invention may change each certain number into identical codons or mutated codons of specific codons corresponding to the certain number, using the transition matrices.

Subsequently, the simulation module according to one embodiment of the present invention may generate mutated genome sequences by merging changed codons with codons in prior seed genome sequences.

Subsequently, the display module according to one embodiment of the present invention may display generated mutated genome sequences (S12400). As described above, the mutated genome sequences may be displayed as visual content such as a graphic image or the like.

### [Mode]

As described above, related contents were disclosed in the best embodiments of the present invention.

### INDUSTRIAL APPLICABILITY

As described above, the present invention is entirely or partially applicable to a method and device for predicting mutated genome sequences, and storage media for storing a mutated genome sequence prediction program.

1. A device for predicting mutated genome sequences as a calculation module to calculate genome mutation between a first genome sequence group and a second genome sequence group using a distributed processing technique after receiving input of the first genome sequence group and the second sequence group, wherein each of the first genome sequence group and the second genome sequence group comprises a plurality of genome sequences, and each of multiple mutation parameters as parameter generation modules generating the multiple mutation parameters with a result of the calculation is represented by a 61 by 61 matrix, comprising:
a simulation module generating mutated genome sequences of seed genome sequences using the multiple mutation parameters; and
a display module to display the generated mutated genome sequences.

2. The device according to claim 1, wherein the calculation module divides genome sequences comprised in the first genome sequence group and the second genome sequence group into a codon unit.

3. The device according to claim 2, wherein the calculation module divides each of the first genome sequence group and the second genome sequence group into a plurality of regions, and calculate genome mutation between regions corresponding to an identical region of each of genome sequence groups in regions comprised in the first genome sequence group and regions comprised in the second genome sequence group.

4. The device according to claim 3, wherein the calculation module calculates at the codon unit to calculate genome mutation between regions corresponding to an identical position in each of the genome sequence groups.

5. The device according to claim 1, wherein the simulation module divides the seed genome sequences into a codon unit and generates certain numbers between 0 and 1 per positions corresponding to positions of specific codons in the seed genome sequences.

6. The device according to claim 5, wherein the simulation module generates codons identical to the specific codons or mutated codons per position of each of the generated certain numbers using the multiple mutation parameters, and changing the specific codons in the seed genome sequences into the generated identical codons or the mutated codons.

7. The device according to claim 6, wherein the simulation module merges the change codons with unchanged codons in the seed genome sequences to generate the mutated genome sequences.

8. The device according to claim 1, wherein the generated mutated genome sequences is displayed visual content such as a graphic image or the like.

9. The device according to claim 1, wherein the multiple mutation parameters are generated in a number of corresponding to a total number of codons in the seed genome sequences minus 1, and the multiple mutation parameters comprise position information of the codons.

10. A method of predicting mutated genome sequences comprising:
receiving input of a first genome sequence group and a second sequence group;
calculating mutation between the first genome sequence group and the second genome sequence group genome using a distributed processing technique, each of the first genome sequence group and the second genome sequence group comprising a plurality of genome sequences;
generating multiple mutation parameters using the calculation result, each of the multiple mutation parameters being represented by a 61 by 61 matrix;
generating mutated genome sequences of seed genome sequences using the multiple mutation parameters; and
displaying the generated mutated genome sequences.

11. The method according to claim 10, wherein the calculating comprises dividing genome sequences in the first genome sequence group and the second genome sequence group into a codon unit.

12. The method according to claim 11, wherein the calculating further comprises dividing each of the first genome sequence group and the second genome sequence group into a plurality of regions; and calculating genome mutation between regions corresponding to an identical position of each genome sequence group, regarding regions comprised in the first genome sequence group and regions comprised in the second genome sequence group.

13. The method according to claim 12, wherein the calculating calculates at the codon unit to calculate genome mutation between regions corresponding to an identical position of each genome sequence group.

14. The method according to claim 10, wherein the mutation genome sequence generating comprises dividing the seed genome sequences into a codon unit; and generating certain numbers between 0 and 1 per positions corresponding to positions of specific codons in the seed genome sequences.

15. The method according to claim 14, wherein the mutation genome sequence generating further comprises generating codons identical to the specific codons or mutated codons per positions of the generated certain numbers using the multiple mutation parameters; and
changing the specific codons in the seed genome sequences into the generated identical codons or the mutated codons.

16. The method according to claim 15, wherein the mutation genome sequence generating comprises merging the changed codons and unchanged codons in the seed genome sequences to generate the mutated genome sequences.

17. The method according to claim 10, wherein the generated mutated genome sequences are displayed in visual content such as a graphic image and the like.

18. The method according to claim 10, wherein the multiple mutation parameters are generated in a number of corresponding to a total number of codons in the seed genome sequences minus 1 and comprise position information of the codons.

19. A storage medium for storing a mutated genome sequence prediction program to receive input of a first genome sequence group and a second sequence group comprising each of a plurality of genome sequences, to calculate genome mutation between the first genome sequence group and the second genome sequence group using a distributed processing technique, to generate multiple mutation parameters represented by a 61 by 61 matrix using the calculation result, to generate mutated genome sequences of seed genome sequences using the multiple mutation parameters, and to display the generate mutated genome sequences.
